(19) United States
(12) Patent Application Publication
(10) Pub. No.: US 2021/0229676 A1
(43) Pub. Date: Jul. 29, 2021

(54) MOVEMENT-ASSISTANCE-INFORMATION PRESENTATION CONTROL DEVICE, METHOD, AND PROGRAM

(71) Applicant: Nippon Telegraph and Telephone Corporation, Tokyo (JP)

(72) Inventors: Yuki YANO, Tokyo (JP); Tatsuya ISHIHARA, Tokyo (JP); Takao KURAHASHI, Tokyo (JP); Tadashi NUNOBIKI, Tokyo (JP)

(21) Appl. No.: 15/734,840

(22) PCT Filed: May 30, 2019
(86) PCT No.: PCT/JP2019/021497

§ 371 Date: Dec. 3, 2020

(30) Foreign Application Priority Data
Jun. 6, 2018 (JP) 2018-108726

(51) Int. Cl. B60W 40/09; B60W 50/14; G06K 9/00; G06K 9/62

(52) U.S. Cl. CPC B60W 40/09; B60W 50/14; B60W 2420/403; G06K 9/6232; B60W 2050/146; G06K 9/00791

(57) ABSTRACT

In order to enable support information to be presented at a timing that is appropriate for a user, a movement support information presentation control apparatus according to an embodiment of the present invention estimates an audio environment and a visual environment that surrounds the user in addition to a driving performance of the user and an operation state of a driving apparatus 2. In addition, based on these estimation results, suitability of information presentation is determined for each type of presentation sections 81 to 83 and, when it is determined that information presentation is not suitable, control is performed so as to postpone an information presentation operation by a corresponding presentation section.

### TECHNICAL FIELD

An embodiment of the present invention relates to a movement support information presentation control apparatus, a method, and a program.

### BACKGROUND ART

As an apparatus that presents information for supporting driving to a user driving a vehicle, for example, a car navigation apparatus is known in the automotive field, and examples of proposed functions thereof include the following.

(1) Function of always displaying support information on a screen. The user can change a display position or a display type of the support information by operating a button, a touch panel, or other operating means.

(2) Function of automatically presenting, for example, when it is determined based on position information of a vehicle that the vehicle has approached within a certain distance of a destination or the like, information of the approach.

(3) Function of expanding the functions described above to control a presentation timing and a presentation method based on image information of the user, a state of the vehicle, and the like. Examples of these functions are described in NPL 1, 2, and 3.

### CITATION LIST

### Non Patent Literature

[NPL 1] SeungJun Kim, Jaemin Chun, and Anind K. Dey, “Sensors Know When to Interrupt You in the Car”, ResearchGate, All content following this page was uploaded by Anind K. Dey on 28 Apr. 2016, <URL: https://www.researchgate.net/publication/300725639>
[NPL 2] Jung Wook Park, Anind K. Dey, and SeungJun Kim, “Integrated Driving Aware System in the Real-World: Sensing, Computing and Feedback”, CHI'16 Extended Abstracts, May 7-12, 2016, San Jose, Calif., USA, ACM 978-1-4503-4082-3/16/05, <URL: http://dx.doi.org/10.1145/2851581.2892309>
[NPL 3] Masaki Yamaoka, Sunao Hara, Masanobu Abe, “Influence analysis on user's workload in a spoken dialog strategy for a car navigation system”, Japan, The Special Interest Group Technical Reports of IPSJ, VoL. 2014-NL-216 No. 7, VoL. 2014-SLP-101 No. 7, 2014 May 22

### SUMMARY OF THE INVENTION

### Technical Problem

However, each conventionally proposed function described above has room for improvement as will be described below.

With the function involving the user instructing presentation of support information by performing a manual operation described in (1), since the user must perform a presentation operation of the support information while driving, the operation becomes a hassle for the user and the action of performing the presentation operation ends up obstructing driving.

With the function of presenting support information in accordance with a vehicle position described in (2), since the support information is to be presented without any consideration for a state of the user, for example, when the support information is presented in a case where the user needs to be sufficiently focused such as when approaching a curve or passing a pedestrian crossing, the user may fail to notice presented information or may feel that the presented information is bothersome, or the presented information may interfere with the user's concentration.

NPL 1 to 3 which disclose the presentation control function described in (3) have, for example, the following problems.

First, the technique described in NPL 1 is limited to estimating an information presentation timing mainly using information regarding the inside of a vehicle, and NPL 1 fails to disclose a specific information presentation method in accordance with an estimation result.

Next, while the technique described in NPL 2 takes into consideration vehicle body information of a vehicle, biological information of a user, and GPS information when presenting support information, surrounding circumstances outside of a vehicle are not taken into consideration. Therefore, there may be cases in which support information is presented even in a situation where, for example, a step, an obstacle, or the like is present on a road in a direction of movement and, in such cases, the support information may distract the user, delay an avoidance maneuver, and end up causing an accident such as running off a shoulder of the road or a collision.

On the other hand, NPL 3 represents a concept in which information presentation is only performed when surrounding circumstances are suitable for such information presentation. However, NPL 3 fails to disclose specific evaluation results with respect to, for example, what kind of surrounding circumstances are actually suitable for information presentation.

The present invention has been made in consideration of the circumstances described above and an object thereof is to provide a technique that enables support information to be presented under conditions more appropriate for a user.

### Means for Solving the Problem

In order to achieve the object described above, a first aspect of the present invention includes: a generating section that generates support information to be presented to a user who is traveling on a vehicle; a surrounding environment estimating section which acquires sensor information corresponding to a surrounding environment of the vehicle and which estimates the surrounding environment based on a feature amount included in the acquired sensor information; and a control section that controls a presentation operation of the generated support information with respect to the user based on an estimation result of the surrounding environment.

According to the first aspect of the present invention, a surrounding environment of a vehicle is estimated during a movement of a vehicle, and a presentation operation of support information with respect to a user aboard the vehicle is controlled based on an estimation result thereof.

In a second aspect of the present invention, the surrounding environment estimating section acquires auditory sensor information corresponding to a surrounding auditory environment of the vehicle and, by comparing a feature amount included in the acquired auditory sensor information with a first determination condition set in advance, determines whether or not the surrounding auditory environment is suitable for presentation of the support information. In addition, when it is determined that the auditory environment is not suitable for presentation of the support information, the control section postpones at least a presentation operation of the support information that utilizes an auditory sense of the user.

According to the second aspect of the present invention, when it is determined that a surrounding auditory environment around the vehicle is not suitable for presentation of support information based on a feature amount that represents the auditory environment, a presentation operation of the support information that utilizes an auditory sense is not performed but, rather, postponed. Therefore, a problem in that the user does not notice the presentation of the support information can be prevented and a situation where the user forces himself/herself to listen to a barely perceptible auditory information presentation can be eliminated and, accordingly, adverse effects to a driving operation can be avoided.

In a third aspect of the present invention, the surrounding environment estimating section acquires visual sensor information corresponding to a visual environment around the vehicle and, by comparing a feature amount included in the acquired visual sensor information with a second determination condition set in advance, determines whether or not the visual environment around the vehicle is suitable for presentation of the support information. In addition, when it is determined that the visual environment is not suitable for presentation of the support information, the control section postpones at least a presentation operation of the support information that utilizes a visual sense of the user.

According to the third aspect of the present invention, when it is determined that a visual environment around the vehicle is not suitable for presentation of support information based on a feature amount that represents the visual environment, a presentation operation of the support information that utilizes a visual sense is not performed but, rather, postponed. Therefore, a lapse in visual perception of the support information by the user can be prevented. In addition, a situation where the user's focus on support information draws attention away from a driving operation can be avoided.

A fourth aspect of the present invention further includes a vehicle state estimating section which, by acquiring sensor information corresponding to a vibration of the vehicle and comparing a feature amount included in the acquired sensor information with a third determination condition set in advance, determines whether or not the vibration of the vehicle is suitable for presentation of the support information. In addition, when it is determined that the vibration of the vehicle is not suitable for presentation of the support information, control is further performed to postpone at least a presentation operation of the support information that utilizes a haptic sense of the user.

According to the fourth aspect of the present invention, in a case where a significant vibration is generated in the vehicle such as when traveling on a road with poor road surface conditions, a determination is made that the case is not suitable for presentation of the support information using the haptic sense. Therefore, a problem in that the user does not notice a presentation of the support information can be prevented.

A fifth aspect of the present invention further includes a driving skill estimating section which, by acquiring sensor information corresponding to a driving skill of the user for the vehicle and comparing a feature amount included in the acquired sensor information corresponding to the driving skill with a fourth determination condition set in advance, determines whether or not the driving skill of the user is suitable for presentation of the support information. In addition, when it is determined that the driving skill of the user is not suitable for presentation of the support information, control is further performed to postpone a presentation operation of the support information with respect to the user.

According to the fifth aspect of the present invention, when it is determined that the driving skill of the user has declined and is not suitable for presentation of the support information, a presentation of the support information with respect to the user is not performed but, rather, postponed. Therefore, the user can focus on a driving operation without being affected by a presentation of the support information.

A sixth aspect of the present invention further includes a determination condition control section which, based on a determination result of the driving skill of the user as obtained by the driving skill estimating section after a presentation operation of the support information is performed, determines whether the driving skill of the user after the presentation of the support information is maintained or declined and, based on the determination result, variably controls at least one of the first, second, third, and fourth determination conditions.

According to the sixth aspect of the present invention, for example, when the driving skill of the user declines after the presentation of the support information, the determination condition for determining suitability of presentation of the support information by the estimating section is variably set to a more stringent value. Therefore, even when a determination condition set in advance is not suitable for the user, since the determination condition is changed during use, presentation control of support information that is suitable for the driving skill of the user can be performed.

### Effects of the Invention

According to the respective aspects of the present invention, a technique can be provided which enables support information to be presented under conditions more appropriate for a user.

### BRIEF DESCRIPTION OF DRAWINGS

FIG. 1 is a block diagram showing an example of a functional configuration of a movement support information presentation control apparatus according to an embodiment of the present invention.

FIG. 2 is a flow chart showing an example of processing procedures and processing contents by a driving performance estimating section among the respective functional components shown in FIG. 1.

FIG. 3 is a flow chart showing an example of processing procedures and processing contents by an apparatus state estimating section among the respective functional components shown in FIG. 1.

FIG. 4 is a flow chart showing an example of processing procedures and processing contents by an audio environment estimating section among the respective functional components shown in FIG. 1.

FIG. 5 is a flow chart showing an example of processing procedures and processing contents by a visual environment estimating section among the respective functional components shown in FIG. 1.

FIG. 6 is a flow chart showing an example of processing procedures and processing contents by a feedback determining section and a parameter adjusting section among the respective functional components shown in FIG. 1.

### DESCRIPTION OF EMBODIMENTS

Hereinafter, embodiments of the present invention will be described with reference to the drawings.

### One Embodiment

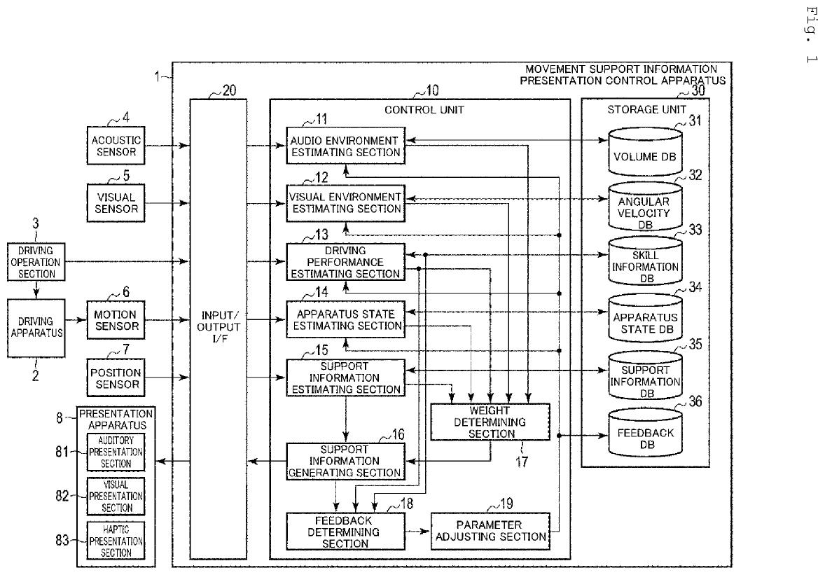

FIG. 1 is a block diagram showing an example of a functional configuration of a movement support information presentation control apparatus according to an embodiment of the present invention.

A movement support information presentation control apparatus 1 according to the embodiment is provided in, for example, a general automobile or an electric vehicle for the elderly or the disabled which is referred to as personal mobility and is constituted by an onboard computer equipped with a processor and a memory. In this case, the onboard computer may be exclusively used by the movement support information presentation control apparatus 1 or may be shared with an apparatus that executes other control such as driving control.

The movement support information presentation control apparatus 1 is equipped with a control unit 10, an input/output interface unit (an input/output I/F) 20, and a storage unit 30. The input/output I/F 20 has a function of fetching operation data output from a driving operation section 3 that operates a driving apparatus 2 and sensor data output from a sensor group provided in a vehicle and, at the same time, outputting support information generated by the control unit 10 to a presentation apparatus 8.

The driving apparatus 2 is equipped with a drive unit and a steering unit. The drive unit has, for example, a battery, a motor, and control circuits thereof, and transmits a drive force thereof to wheels via a drive mechanism. The steering unit controls a movement direction of the vehicle in accordance with an operation of the driving operation section 3. As the driving operation section 3, for example, a joystick is used in the case of personal mobility.

For example, the sensor group includes an acoustic sensor 4 that is constituted by a microphone, a visual sensor 5 that uses a camera or the like, a motion sensor 6 that detects an operation state of the driving apparatus 2, and a position sensor 7 that utilizes GPS (Global Positioning System). Among these sensors, as the visual sensor 5, a depth camera, a laser range finder, or the like can also be used. In addition, as the motion sensor 6, for example, a vehicle gyro sensor that uses an acceleration sensor or an angular velocity sensor is used.

The storage unit (memory) 30 uses a nonvolatile memory capable of read and write such as an HDD (Hard Disk Drive) or an SSD (Solid State Drive) as a storage medium and is equipped with a program storage area and a data storage area. A volume database 31, an angular velocity database 32, a skill information database 33, an apparatus state database 34, a support information database 35, and a feedback database 36 are provided in the data storage area. Hereinafter, a database will be referred to as a DB.

The volume DB 31 is used to store volume data around the vehicle. The angular velocity DB 32 is used to store angular velocity data that, for example, mainly represents a motion of the vehicle in a direction (hereinafter, also sometimes simply referred as a horizontal direction) parallel to a road surface. The skill information DB 33 is used to store information representing an estimation result of a driving performance of a user (a driver). The apparatus state DB 34 is used to store angular acceleration data that, for example, mainly represents a motion of the vehicle in an up-down direction (hereinafter, also sometimes simply referred as a vertical direction). The support information DB 35 stores, in advance, basic support information for generating support information. The feedback DB 36 is used to store various thresholds as determination conditions to be used by respective estimating sections of the control unit 10 to be described later in order to determine feasibility of presentation of support information.

The control unit (controller) 10 is equipped with, for example, a hardware processor that is referred to as a CPU (Central Processing Unit). As control functions related to the present embodiment, the control unit 10 is equipped with an audio environment estimating section 11, a visual environment estimating section 12, a driving performance estimating section 13, an apparatus state estimating section 14, a support information estimating section 15, a support information generating section 16, a weight determining section 17, a feedback determining section 18, and a parameter adjusting section 19. All of these processing functions are realized by having the hardware processor execute a program stored in a program area of the storage unit 30.

The audio environment estimating section 11 fetches acoustic data including noise and voices around the vehicle as detected by the acoustic sensor 4 via the input/output I/F 20, detects a feature amount (for example, a volume) of sound around the vehicle at prescribed intervals from the acoustic data, and causes the volume DB 31 to store the data. In addition, the audio environment estimating section 11 calculates a deviation of a present volume based on a group of past volume data that is stored in the volume DB 31, determines feasibility of presentation of support information by the auditory sense based on the volume deviation, and outputs the determination data to the weight determining section 17.

The visual environment estimating section 12 fetches gyro data representing a motion of the vehicle as measured by the motion sensor 6 via the input/output I/F 20, extracts tilt angular velocity data that represents a feature of the motion of the vehicle in the horizontal direction at prescribed intervals from the gyro data, and causes the angular velocity DB 32 to store the extracted data. In addition, the visual environment estimating section 12 calculates a deviation of a present tilt angular velocity based on a group of past tilt angular velocity data that is stored in the angular velocity DB 32, determines feasibility of presentation of support information by the visual sense based on the tilt angular velocity deviation, and outputs the determination data to the weight determining section 17.

Furthermore, the visual environment estimating section 12 fetches image data of a front of the vehicle as captured by the visual sensor 5 via the input/output I/F 20 and determines a presence or absence of an obstacle in the front of the vehicle at prescribed intervals based on the image data. In addition, the visual environment estimating section 12 determines feasibility of presentation of support information by the visual sense based on the determination result and outputs the determination data to the weight determining section 17.

The driving performance estimating section 13 fetches operation data that is output from the driving operation section 3 via the input/output I/F 20, evaluates a driving performance (a driving skill) of the driver at prescribed intervals based on the operation data, and causes the skill information DB 33 to store the evaluation data. In addition, the driving performance estimating section 13 calculates a deviation of a present driving skill based on a group of past evaluation data that is stored in the skill information DB 33, determines feasibility of presentation of support information based on the deviation of the driving skill, and outputs the determination data to the weight determining section 17.

The apparatus state estimating section 14 fetches gyro data representing a motion of the vehicle as measured by the motion sensor 6 via the input/output I/F 20, extracts tilt angular acceleration data that represents a feature of the motion of the vehicle in the vertical direction at prescribed intervals from the gyro data, and causes the apparatus state DB 34 to store the extracted data. In addition, the apparatus state estimating section 14 calculates a deviation of a present tilt angular acceleration based on a group of past tilt angular acceleration data that is stored in the apparatus state DB 34, determines feasibility of presentation of support information by the haptic sense based on the tilt angular acceleration deviation, and outputs the determination data to the weight determining section 17.

The weight determining section 17 determines a weight coefficient for each presentation method using a logical operational expression prepared in advance based on respective pieces of determination data output from the audio environment estimating section 11, the visual environment estimating section 12, the driving performance estimating section 13, and the apparatus state estimating section 14, and outputs the weight coefficients to the support information generating section 16. There are three presentation methods, namely, the auditory sense, the visual sense, and the haptic sense.

The support information estimating section 15 fetches positional data of the vehicle as detected by the position sensor 7 via the input/output I/F 20, selects guidance information to, for example, a destination based on the positional data from the support information DB 35 as support information, and outputs the selected support information to the support information generating section 16.

The support information generating section 16 determines a presentation method of the support information output from the support information estimating section 15 in accordance with the weight coefficient output from the weight determining section 17. In addition, the support information generating section 16 outputs the support information to presentation sections 81 to 83 that correspond to the determined presentation methods.

The feedback determining section 18 acquires estimation data of a driving performance after the presentation of support information by the support information generating section 16 from the driving performance estimating section 13. In addition, the feedback determining section 18 compares the acquired estimation data to a group of past estimation data that is stored in the skill information DB 33 and determines whether or not the driving performance has declined.

The parameter adjusting section 19 variably sets a threshold used by the driving performance estimating section 13 based on a determination result by the feedback determining section 18.

(Operations)

Next, a presentation control operation of movement support information by the apparatus configured as described above will be described.

A case where movement support information is presented to a user (a driver) in personal mobility will now be described as an example.

The support information DB 35 stores, in advance, a plurality of pieces of support information to be a presentation candidate in a state where a label indicating a priority is attached thereto. The skill information DB 33 stores, in a time series, estimation data of a driving performance of the user up to the present. The apparatus state DB 34 stores, in a time series, data indicating a velocity or a tilt that represents a feature of a motion of the vehicle of the user up to the present.

Let us assume that, in this state, the user sits on a driver's seat of the personal mobility and, for example, after inputting and setting a destination, starts driving the personal mobility by operating a joystick. As a result, during the driving, the movement support information presentation control apparatus 1 performs presentation control of movement support information as described below under control of the control unit 10.

(1) Estimation of Support Information

Under control of the support information estimating section 15, the control unit 10 executes processing such as that described below.

Specifically, the control unit 10 determines whether or not the vehicle has approached the destination based on present positional data as measured by the position sensor 7 and information on the destination set in advance. In addition, when the control unit 10 determines that the vehicle has approached the destination, the control unit 10 selects guidance information thereof from the support information DB 35 and outputs the guidance information to the support information generating section 16. Furthermore, the control unit 10 monitors whether or not, for example, an emergency vehicle has approached. In addition, when the control unit 10 determines that an emergency vehicle has approached, the control unit 10 selects guidance information thereof from the support information DB 35 and outputs the guidance information to the support information generating section 16. At this point, a priority label that indicates a priority of information presentation is attached to both of the pieces of guidance information.

(2) Control of Weight Coefficient Based on Driving Performance

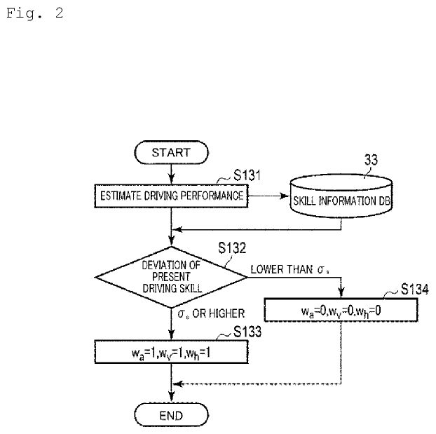

FIG. 2 is a flow chart showing processing procedures and processing contents of the driving performance estimating section 13.

In step S131, under control of the driving performance estimating section 13, the control unit 10 fetches operation data from the driving operation section 3 via the input/output I/F 20. In addition, based on the fetched operation data, the control unit 10 estimates a driving performance (a driving skill) of the user independent of a surrounding environment at prescribed intervals (for example, 1 second intervals). For example, based on a frequency of operations, an amount of change of operations, and the like of the joystick per unit time, a smoothness of operations and the like are evaluated in a range from “0” to “100”. Furthermore, the control unit 10 causes the skill information DB 33 to sequentially store the evaluation data.

In addition, under control of the driving performance estimating section 13, the control unit 10 calculates a deviation of a present driving performance based on a group of past evaluation data that is stored in the skill information DB 33. Furthermore, in step S132, the control unit 10 determines whether the calculated deviation of the driving performance is equal to or higher than or lower than a threshold σₛ that is set as a parameter.

As a result of the determination, when the deviation of the present driving performance is equal to or higher than the threshold σₛ, the control unit 10 determines that, at a present timing, the driving performance of the user is high, and presentation of movement support information is possible. In addition, in this case, in step S133, the control unit 10 sets all of a weight coefficient wₐ for auditory presentation, a weight coefficient wᵥ for visual presentation, and a weight coefficient wₕ for haptic presentation to “1”.

Conversely, let us assume that, as a result of the determination, the deviation of the present driving performance is lower than the threshold σₛ. In this case, the control unit 10 determines that the driving performance of the user is low and, at a present timing, presenting movement support information is not suitable. In addition, in step S134, the control unit 10 sets all of the weight coefficient wₐ for auditory presentation, the weight coefficient wᵥ for visual presentation, and the weight coefficient wₕ for haptic presentation to “0”.

Furthermore, when determining the deviation of the driving performance, the control unit 10 adjusts the threshold σₛ based on a priority label being attached to movement support information that is presently considered a presentation object. For example, when displaying movement support information with high importance, the threshold σₛ is set to a value that is lower than a standard value in accordance with a priority of the priority label so that support information can be presented even in a state where the driving performance of the driver has declined. On the other hand, when displaying movement support information with low importance, the threshold σₛ is set to a value that is higher than the standard value so that the user can focus on driving operations without being affected by a presentation of support information.

In the control of the threshold σₛ in accordance with the priority of the support information described above, for example, a priority label may be individually attached to each presentation method or, in other words, to each of “for visual sense”, “for auditory sense”, and “for haptic sense” in correspondence to support information, and the threshold σₛ for determining a driving performance may be variably controlled in accordance with the priority label for each presentation method.

(3) Control of Weight Coefficient Based on State of Vehicle

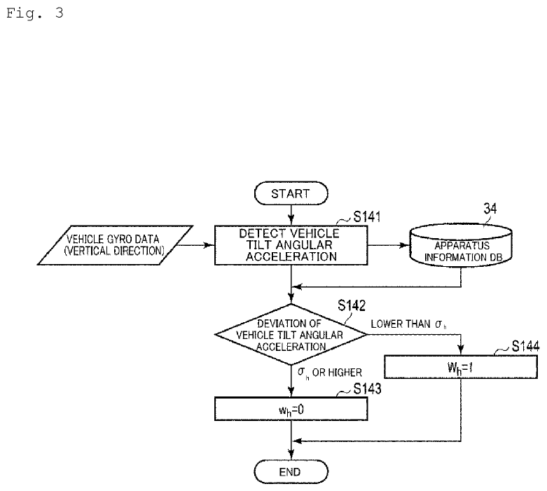

FIG. 3 is a flow chart showing processing procedures and processing contents of the apparatus state estimating section 14.

In step S141, under control of the apparatus state estimating section 14, the control unit 10 fetches gyro data as detected by the motion sensor 6 via the input/output I/F 20. In addition, from the fetched gyro data, the control unit 10 detects data indicating a tilt angular acceleration of the vehicle which is a feature amount representing a motion of the vehicle in the up-down direction. The detected data of the tilt angular acceleration of the vehicle is stored in the apparatus state DB 34.

Next, in step S142, the control unit 10 calculates a deviation of the present tilt angular acceleration data based on a group of past tilt angular acceleration data that is stored in the apparatus state DB 34. In addition, the calculated deviation of the present tilt angular acceleration is compared with a threshold σₕ. As a result of the comparison, for example, when the deviation of the present tilt angular acceleration data is equal to or higher than the threshold σₕ, a determination that a vertical vibration of the vehicle is large and haptic presentation is inappropriate is made and, in step S143, the weight coefficient wₕ for haptic presentation is set to “0”.

Conversely, let us assume that, as a result of the comparison, the deviation of the present tilt angular acceleration data is lower than the threshold σₕ. As a result of the comparison, the control unit 10 determines that a vertical vibration of the vehicle is small and haptic presentation is possible and, in step S144, the control unit 10 sets the weight coefficient wₕ for haptic presentation to “1”.

(4) Control of Weight Coefficient Based on Surrounding Audio Environment

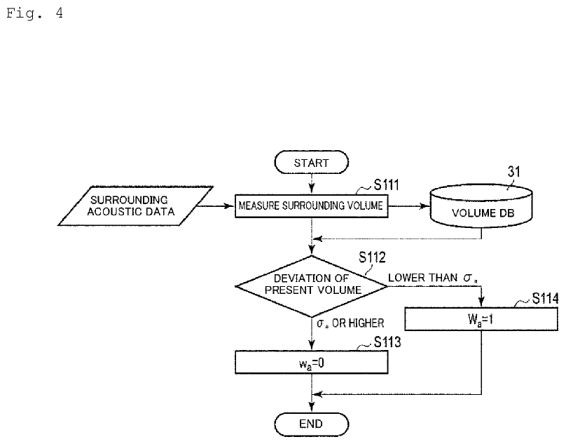

FIG. 4 is a flow chart showing processing procedures and processing contents of the audio environment estimating section 11.

First, in step S111, under control of the audio environment estimating section 11, the control unit 10 fetches surrounding acoustic data as detected by the acoustic sensor 4 via the input/output I/F 20 and detects a volume indicating a feature amount of sound around the vehicle at prescribed intervals from the acoustic data. The detected volume data is stored in the volume DB 31.

Next, in step S112, the control unit 10 calculates a deviation of the present volume data based on a group of past volume data that is stored in the volume DB 31 and compares the volume deviation with a threshold σₐ. As a result of the comparison, when the deviation of the present volume data is equal to or higher than the threshold σₐ, the control unit 10 determines that the volume of surrounding audio is high and auditory presentation is inappropriate and, in step S113, the control unit 10 sets the weight coefficient wₐ for auditory presentation to “0”.

Conversely, let us assume that, as a result of the comparison, the deviation of the present volume data is lower than the threshold σₐ. In this case, the control unit 10 determines that the volume of surrounding audio is low and auditory presentation is possible and, in step S114, the control unit 10 sets the weight coefficient wₐ for auditory presentation to “1”.

(5) Control of Weight Coefficient Based on Visual Environment

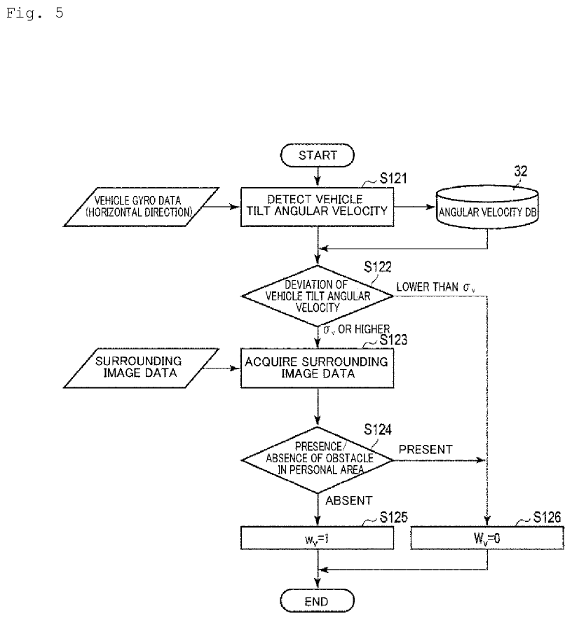

FIG. 5 is a flow chart showing processing procedures and processing contents of the audio environment estimating section 11.

First, in step S121, under control of the visual environment estimating section 12, the control unit 10 fetches gyro data representing a motion of the vehicle as measured by the motion sensor 6 via the input/output I/F 20. In addition, from the fetched gyro data, the control unit 10 detects tilt angular velocity data that represents a feature amount of a motion of the vehicle in a horizontal direction at prescribed intervals. The detected tilt angular velocity data is stored in the angular velocity DB 32.

Next, in step S122, the control unit 10 calculates a deviation of the present tilt angular velocity based on a group of past tilt angular velocity data that is stored in the angular velocity DB 32 and compares the tilt angular velocity deviation with a threshold σᵥ. As a result of the comparison, when the deviation of the present tilt angular velocity is equal to or higher than the threshold σᵥ, the control unit 10 determines that the vehicle is about to negotiate a curve and visibility is poor and that information presentation by the visual sense is inappropriate and, in step S126, the control unit 10 sets the weight coefficient wᵥ for visual presentation to “0”.

Conversely, let us assume that, as a result of the comparison, the deviation of the present tilt angular velocity is lower than the threshold σᵥ. In this case, the control unit 10 makes a transition to step S123 and fetches sensor data of front of the vehicle as captured by the visual sensor 5 via the input/output I/F 20. Next, in step S124, based on the acquired sensor data, the control unit 10 determines whether or not an obstacle is present in a direction of travel or to a side of the vehicle or, in other words, whether or not an obstacle is present inside a personal space.

A personal space is defined as a threshold of a distance at which a person normally feels uncomfortable and is generally set to a narrow range of 1 to 2 m. However, the personal space is desirably varied in accordance with movement conditions such as a movement velocity of the vehicle, time conditions such as morning, day, or night, congestion conditions of surroundings, and the like. In consideration thereof, in the present embodiment, the personal space is variably set in accordance with the various conditions. Accordingly, suitability of presentation of visual information can be more appropriately determined in accordance with a change in the actual visual environment.

For example, a presence or absence of an obstacle is determined by the visual environment estimating section 12 as follows. Specifically, when a camera is used as the visual sensor 5, the visual environment estimating section 12 stores, in advance, reference image patterns of various obstacles such as a person, a telephone pole, a sign, a billboard, a bicycle, and a step that are assumed as obstacles and makes a determination by performing pattern matching processing between image data acquired by the camera and the reference image patterns of the obstacles.

In addition, when a depth camera or a laser range finder is used as the visual sensor 5, the visual environment estimating section 12 determines the presence or absence of an obstacle by, for example, comparing depth information obtained by the depth camera or the laser range finder with a threshold.

In addition, let us assume that, as a result of the comparison, an obstacle is not detected from the sensor data acquired from the visual sensor 5. In this case, the visual environment estimating section 12 determines that presentation of support information by the visual sense is possible and, in step S125, sets the weight coefficient wᵥ for visual presentation to “1”. Conversely, let us assume that, as a result of the comparison, an obstacle is detected from the acquired sensor data. In this case, the visual environment estimating section 12 determines that presentation of support information by the visual sense is inappropriate and, in step S126, sets the weight coefficient wᵥ for visual presentation to “0”.

(6) Determination of Weight Coefficient and Presentation Control of Support Information

The weight determining section 17 stores a logical operational expression. The logical operational expression is used to calculate a comprehensive weight coefficient based on weight coefficients respectively set by the driving performance estimating section 13, the apparatus state estimating section 14, the audio environment estimating section 11, and the visual environment estimating section 12 and is expressed as

w(driving skill)∩(w(apparatus state)∨w(audio environment)∨w(visual environment)).

More specifically, the logical operational expression is expressed as

w(wₐ,wᵥ,wₕ)∩(w(wₕ)∨w(wₐ)∨w(wᵥ).

The weight determining section 17 substitutes the weight coefficients respectively set by the driving performance estimating section 13, the apparatus state estimating section 14, the audio environment estimating section 11, and the visual environment estimating section 12 into the logical operational expression to calculate the comprehensive weight coefficient.

For example, let us assume that the respective weight coefficients wₐ, wᵥ, and wₕ set by the driving performance estimating section 13 are all “1”, the weight coefficient wₕ set by the apparatus state estimating section 14 is “1”, and the weight coefficients wₐ and wᵥ respectively set by the audio environment estimating section 11 and the visual environment estimating section 12 are both “0”. In this case, the comprehensive weight coefficient is w (0, 0, 1). Therefore, the support information generating section 16 outputs support information such as guidance information to the effect that the vehicle has approached a destination to a haptic presentation section 83 of the presentation apparatus 8. Therefore, if the haptic presentation section 83 is constituted by, for example, a vibrator and the vibrator is arranged on a driver's seat surface or the like of the vehicle, the vibrator vibrates to notify the user of the support information.

In addition, let us assume that the respective weight coefficients wₐ, wᵥ, and wₕ set by the driving performance estimating section 13 are all “1”, the weight coefficient wₕ set by the apparatus state estimating section 14 and the weight coefficient wₐ set by the audio environment estimating section 11 are both “0”, and the weight coefficient wᵥ set by the visual environment estimating section 12 is “1”. In this case, the comprehensive weight coefficient is w (0, 1, 0). Therefore, the support information generating section 16 outputs display data of support information to a visual presentation section 82 of the presentation apparatus 8. Therefore, if the visual presentation section 82 is constituted by, for example, a display and the display is installed on a console of the vehicle, the display data of the support information is displayed on the display and the user can recognize contents of the support information from the display data.

Furthermore, let us assume that the respective weight coefficients wₐ, wᵥ, and wₕ set by the driving performance estimating section 13 are all “1”, the weight coefficient wₕ set by the apparatus state estimating section 14 and the weight coefficient wᵥ set by the visual environment estimating section 12 are both “0”, and the weight coefficient wₐ set by the audio environment estimating section 11 is “1”. In this case, the comprehensive weight coefficient is w (1, 0, 0). Therefore, the support information generating section 16 converts the support information into an audio message by, for example, speech synthesis, and outputs the audio message to an auditory presentation section 81 of the presentation apparatus 8. Therefore, if the visual presentation section 82 is constituted by, for example, a speaker and the speaker is installed on a console or the like of the vehicle, an audio message of the support information is output from the speaker and the user can recognize contents of the support information from the audio message.

Alternatively, when the comprehensive weight coefficients wₐ and wᵥ are “1”, an audio message and display data of the support information are respectively output to the auditory presentation section 81 and the visual presentation section 82. In addition, when the comprehensive weight coefficients wₐ and wₕ are “1”, an audio message and a vibrator drive signal of the support information are respectively output to the auditory presentation section 81 and the haptic presentation section 83.

In a similar manner, when the comprehensive weight coefficients wᵥ and wₕ are “1”, display data and a vibrator drive signal of the support information are respectively output to the visual presentation section 82 and the haptic presentation section 83. Furthermore, when the comprehensive weight coefficients wₐ, wᵥ, and wₕ are all “1”, an audio message, display data, and a vibrator drive signal of the support information are respectively output to the auditory presentation section 81, the visual presentation section 82, and the haptic presentation section 83.

On the other hand, when the comprehensive weight coefficients wₐ, wᵥ, and wₕ are all “0”, the support information generating section 16 waits to output support information. In addition, the support information generating section 16 outputs the support information once at least one of the comprehensive weight coefficients wₐ, wᵥ, and wₕ changes to “1”.

(7) Feedback Control of Support Information Presentation Condition

The control unit 10 of the movement support information presentation control apparatus 1 estimates, using the driving performance estimating section 13, a driving performance of the user after presenting the support information. In addition, under control of the feedback determining section 18 and the parameter adjusting section 19, the control unit 10 performs a feedback determination of each threshold (parameter) that constitutes a support information presentation condition and an adjustment of a value thereof as follows.

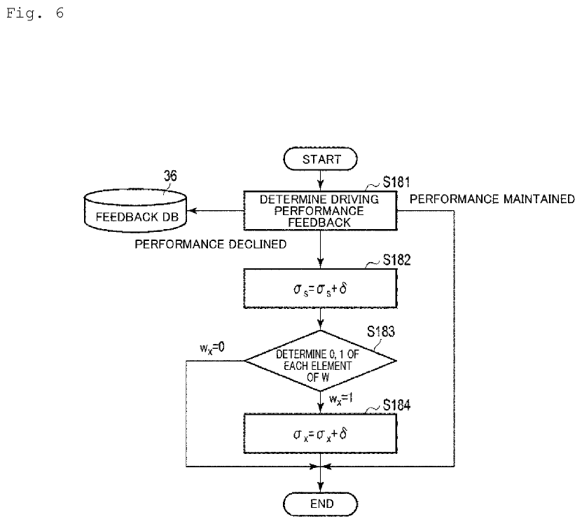

FIG. 6 is a flow chart showing processing procedures and processing contents by the feedback determining section 18 and the parameter adjusting section 19.

Specifically, first, in step S181, the control unit 10 determines whether the driving performance of the user after the presentation of the support information is maintained or declined. This determination is made by comparing present driving performance estimation data as obtained by the driving performance estimating section 13 with estimation data of the previously estimated driving performance that is stored in the feedback DB 36.

As a result of the comparison, if the estimation data of the present driving performance has not changed from the estimation data of the previous driving performance or, in other words, if the user has maintained his/her driving performance, the control unit 10 ends processing as-is without changing a threshold.

Conversely, let us assume that, as a result of the comparison, the estimation data of the present driving performance has declined from the estimation data of the previous driving performance. In this case, in step S182, the control unit 10 changes a threshold σₛ for determining a driving performance to a more stringent value. Specifically, the threshold σₛ used in a previous determination is read from the feedback DB 36, a certain value δ is added to the threshold σₛ, and the threshold σₛ after the addition is adopted as a new threshold. The new threshold σₛ is stored in the feedback DB 36 in association of the estimation data of the present driving performance described above.

Next, under the control of the feedback determining section 18, in step S183, the control unit 10 determines whether each element of the comprehensive weight coefficient w most recently determined by the weight determining section 17 or, in other words, whether each of wₐ, wᵥ, and wₕ is “1” or “0”. In addition, as a result of the determination, in step S183, the control unit 10 changes a threshold σₓ corresponding to an element determined as “1” to a stringent value by adding the constant value δ described above to the threshold σₓ. The threshold ox after the change is set to the corresponding estimating section 11, 12, or 14 that uses the threshold.

In the present embodiment, each of the estimating sections 11 to 15 sets an arbitrary value as a threshold (parameter) for determining suitability of information presentation. Nevertheless, since human cognitive abilities differ from one individual to the next, cases are assumed where a threshold set as a determination condition turns out to be unsuitable for the user. However, by performing a feedback adjustment of an information presentation condition as described above, the thresholds σₛ, σₐ, σᵥ, and σₕ to be used to determine respective pieces of estimation data can be changed to a value that is suitable for a driving performance of the user.

However, in the example of processing shown in FIG. 6, since a step of relaxing the information presentation condition is absent, the information presentation condition ends up being changed to a stringent value in an endless manner. In consideration thereof, when a need arises to change the information presentation condition such as when a user changes or when a driving environment changes, each threshold may be reset by inputting change information of the user or the driving environment to the apparatus 1.

Alternatively, based on information stored in the feedback DB 36, a threshold that is optimal to the user may be set by a method such as machine learning.

### Effects

As described in detail above, in the embodiment of the present invention, the movement support information presentation control apparatus 1 uses various sensors to estimate an audio environment and a visual environment that surround a user in addition to a driving performance of the user and an operation state of a driving apparatus. Furthermore, the movement support information presentation control apparatus 1 determines suitability of information presentation for each type of presentation means based on such estimation results and, when information presentation is not suitable, the movement support information presentation control apparatus 1 waits for information presentation by the presentation means. Therefore, in the embodiment of the present invention, information can be presented for each type of presentation means only when conditions appropriate for performing information presentation are satisfied in consideration of not only the driving performance of the user and the operation state of the driving apparatus but also the surrounding audio environment and visual environment.

For example, in the embodiment of the present invention, when a volume of surrounding noise or audio is higher than a threshold, a determination that information presentation by the auditory presentation section 81 is not appropriate is made and a presentable state is awaited without performing auditory presentation using an audio message or the like. In other words, in a situation where an audio message is hardly audible such as a situation where surrounding noise is loud or a situation where people nearby are talking simultaneously, information presentation by sound is postponed. Therefore, in the embodiment of the present invention, a problem in that a user does not notice information presentation can be prevented and a situation where the user forces himself/herself to listen to a message constituted by a barely perceptible sound can be eliminated and, accordingly, adverse effects to a driving operation can be avoided.

In addition, in the embodiment of the present invention, when a vehicle is about to negotiate a curve and visibility is poor or when a person, an obstacle, a step, or the like is present in a travel direction, information presentation by the visual presentation section 82 is determined as inappropriate. In this case, the control unit 10 does not perform a visual presentation using a display message or the like and waits for a presentable state to be created. In other words, in a situation where attention must be focused in the travel direction, information presentation using the visual sense is postponed. Therefore, in the embodiment of the present invention, a problem in that a user does not notice information presentation can be avoided and, at the same time, a driver can be prevented from becoming distracted by a display message and becoming unreliable in terms of performing driving operations.

Furthermore, in the embodiment of the present invention, when a change in vertical vibration of the driving apparatus 2 exceeds a threshold, a determination that information presentation by the haptic presentation section 83 is not appropriate is made and a state where the vertical vibration of the driving apparatus 2 stops is awaited without performing haptic presentation using a vibrator or the like. In other words, in a situation where the vertical vibration of a vehicle body is significant and a user is less likely to notice information presentation by a vibrator, information presentation using the haptic sense is not performed. Accordingly, in the embodiment of the present invention, a problem in that the user does not notice an information presentation can be prevented.

Moreover, in the embodiment of the present invention, in a state where a driving performance of the user has declined, a determination that information presentation itself is not appropriate is made and information presentation is postponed regardless of the type of the presentation sections 81 to 83. Accordingly, the user can focus on a driving operation without being affected by information presentation.

### OTHER EMBODIMENTS

(1) In the embodiment described above, based on an estimation result of a driving performance, an estimation result of a state of an apparatus, an estimation result of an audio environment, and an estimation result of a visual environment, the weight determining section 17 determines a weight coefficient using a logical formula that is expressed as

w(driving skill)∩(w(apparatus state)∨w(audio environment)∨w(visual environment)).

However, the present invention is not limited thereto, and a weight coefficient may be determined using a logical formula expressed as

w(audio environment)∨w(visual environment)

based solely on an estimation result of an audio environment or an estimation result of a visual environment.

Alternatively, in the present invention, a weight coefficient may be determined by adding one of an estimation result of a driving performance and an estimation result of a state of an apparatus to an estimation result of an audio environment or an estimation result of a visual environment and by using a logical formula that is expressed as

w(driving skill)∨w(apparatus state)∨w(audio environment)∨w(visual environment).

(2) In the embodiment described above, based on an estimation result of a driving performance, an estimation result of a state of an apparatus, an estimation result of an audio environment, and an estimation result of a visual environment, a weight wₐ for the auditory sense, a weight wᵥ for the visual sense, and a weight wₕ for the haptic sense are respectively determined and, based on a result thereof, support information is presented by selectively using the auditory presentation section 81, the visual presentation section 82, and the haptic presentation section 83. However, in the present invention, all of the three presentation sections 81 to 83 need not necessarily be selectively used and support information may be presented using at least one of these presentation sections.

(3) In the embodiment described above, the movement support information presentation control apparatus 1 measures volumes of surrounding noise and a sound created by speech synthesis when estimating an audio environment and determines feasibility of auditory presentation based on a deviation of a measurement value of the volumes. However, the present invention is not limited thereto and the movement support information presentation control apparatus 1 may, for example, classify a synthesized sound into linguistic information and non-linguistic information and measure respective volumes thereof and determine feasibility of auditory information presentation based on a measurement result thereof. In this case, for example, when the volume of linguistic information is lower than a threshold even though the volume of non-linguistic information is higher than a threshold, the movement support information presentation control apparatus 1 performs presentation of support information by audio. Conversely, when the volume of linguistic information is higher than the threshold even though the volume of non-linguistic information is lower than the threshold, the movement support information presentation control apparatus 1 does not perform presentation of support information by audio.

(4) When determining a weight coefficient based on an estimation result of a driving performance by the driving performance estimating section, the movement support information presentation control apparatus 1 may set a different threshold for each time slot. For example, since traffic is often congested during morning and evening time slots, a threshold for determining a driving performance is set to a stringent value but, conversely, the threshold for determining a driving performance is set to a lenient value during time slots such as daytime during which roads are relatively less congested. Accordingly, presentation of support information may be prevented from being performed during congested time slots even in the case of a user with advanced driving skills but, on the other hand, presentation of support information may be performed during less congested time slots even in the case of a user with rudimentary driving skills.

(5) When estimating a visual environment, the movement support information presentation control apparatus 1 may vary a threshold for determining feasibility of visual presentation based on a measurement result of a tilt angular velocity in a horizontal direction of a vehicle. For example, the threshold is set to a stringent value when a deviation of the tilt angular velocity in the horizontal direction of the vehicle equals or exceeds a certain value but, conversely, the threshold is set to a lenient value when a deviation of the tilt angular velocity in the horizontal direction of the vehicle is below the certain value. Accordingly, for example, presentation of support information by the visual sense can be prevented from being performed when a curve in a movement direction has a large curvature or when attempting to negotiate the curve at high speed and, conversely, presentation of support information by the visual sense can be performed when a curve in a movement direction has a small curvature or when attempting to negotiate the curve at low speed.

(6) In the embodiment described above, a case where an object of presentation of support information is a driver has been described as an example. However, when a driving supporter is present on a passenger's seat or in a periphery of the vehicle, the support information may also be presented to the driving supporter. In addition, conditions for determining feasibility of presentation of support information with respect to the driving supporter may be set more leniently than conditions with respect to the driver.

Furthermore, the present invention can be implemented by making various modifications to the configuration, the control procedures, and the control contents of the movement support information presentation control apparatus, the types of movement support information, the types of vehicles, and the like without departing from the scope and spirit of the invention.

In summary, the present invention should not be limited to the embodiment described above and can be implemented by modifying components without departing from the scope of the invention. In addition, various inventions can be formed by appropriately combining the plurality of components disclosed in the embodiment described above. For example, several components may be deleted from all of the components described in the embodiment. Furthermore, components across various embodiments may be appropriately combined.

### REFERENCE SIGNS LIST

1 Movement support information presentation control apparatus
2 Driving apparatus
3 Driving operation section
4 Acoustic sensor
5 Visual sensor
6 Motion sensor
7 Position sensor
8 Presentation apparatus
10 Control unit
11 Audio environment estimating section
12 Visual environment estimating section
13 Driving performance estimating section
14 Apparatus state estimating section
15 Support information estimating section
16 Support information generating section
17 Weight determining section
18 Feedback determining section
19 Parameter adjusting section
20 Input/output I/F
30 Storage unit
31 Volume database
32 Angular velocity database
33 Skill information database
34 Apparatus state database
35 Support information database
36 Feedback database

1. A movement support information presentation control apparatus equipped with a processor, wherein the processor is configured to execute: processing for generating support information to be presented to a user who is traveling on a vehicle; processing for acquiring sensor information corresponding to a surrounding environment of the vehicle and estimating the surrounding environment based on a feature amount included in the acquired sensor information; and processing for controlling a presentation operation of the generated support information with respect to the user based on an estimation result of the surrounding environment.

2. The movement support information presentation control apparatus according to claim 1, wherein the processor is configured to: in the processing for estimating the surrounding environment, acquire auditory sensor information corresponding to a surrounding auditory environment of the vehicle and, by comparing a feature amount included in the acquired auditory sensor information with a first determination condition set in advance, determine whether or not the surrounding auditory environment is suitable for presentation of the support information; and in the processing of controlling a presentation operation of the support information, when it is determined that the auditory environment is not suitable for presentation of the support information, postpone at least a presentation operation of the support information that utilizes an auditory sense of the user.

3. The movement support information presentation control apparatus according to claim 1, wherein the processor is configured to: in the processing for estimating the surrounding environment, acquire visual sensor information corresponding to a visual environment around the vehicle and, by comparing a feature amount included in the acquired visual sensor information with a second determination condition set in advance, determine whether or not the visual environment around the vehicle is suitable for presentation of the support information; and in the processing of controlling a presentation operation of the support information, when it is determined that the visual environment is not suitable for presentation of the support information, postpone at least a presentation operation of the support information that utilizes a visual sense of the user.

4. The movement support information presentation control apparatus according to claim 1, wherein the processor is configured to: further execute vehicle state estimating processing for acquiring sensor information corresponding to a vibration of the vehicle and, by comparing a feature amount included in the acquired sensor information with a third determination condition set in advance, determine whether or not the vibration of the vehicle is suitable for presentation of the support information; and in the processing of controlling a presentation operation of the support information, when it is determined that the vibration of the vehicle is not suitable for presentation of the support information, further perform control to postpone at least a presentation operation of the support information that utilizes a haptic sense of the user.

5. The movement support information presentation control apparatus according to claim 1, wherein the processor is configured to: further execute driving skill estimation processing for acquiring sensor information corresponding to a driving skill of the user for the vehicle and, by comparing a feature amount included in the acquired sensor information corresponding to the driving skill with a fourth determination condition set in advance, determine whether or not the driving skill of the user is suitable for presentation of the support information; and in the processing of controlling a presentation operation of the support information, when it is determined that the driving skill of the user is not suitable for presentation of the support information, further perform control to postpone a presentation operation of the support information with respect to the user.

6. The movement support information presentation control apparatus according to claim 5, wherein the processor is configured to: based on a determination result of the driving skill of the user as obtained by the driving skill estimating processing after a presentation operation of the support information is performed, determine whether the driving skill of the user is maintained or declined after the presentation of the support information and, based on the determination result, further execute control to variably control at least one of the first, second, third, and fourth determination conditions.

7. A presentation control method of movement support information to be executed by an apparatus that is equipped with a processor, the method comprising the steps in which: the processor generates support information to be presented to a user who is traveling on a vehicle;
the processor acquires sensor information corresponding to a surrounding environment of the vehicle and estimates the surrounding environment based on a feature amount included in the acquired sensor information; and the processor controls a presentation operation of the generated support information with respect to the user based on an estimation result of the surrounding environment.

8. A non-transitory computer-readable medium storing one or more instructions causing a computer to execute:
generating support information to be presented to a user who is traveling on a vehicle;
acquiring sensor information corresponding to a surrounding environment of the vehicle and estimating the surrounding environment based on a feature amount included in the acquired sensor information; and
controlling a presentation operation of the generated support information with respect to the user based on an estimation result of the surrounding environment.

9. The non-transitory computer readable medium according to claim 8, wherein the one or more instructions further cause the computer to execute:
in the processing for estimating the surrounding environment, acquire auditory sensor information corresponding to a surrounding auditory environment of the vehicle and, by comparing a feature amount included in the acquired auditory sensor information with a first determination condition set in advance, determine whether or not the surrounding auditory environment is suitable for presentation of the support information; and
in the processing of controlling a presentation operation of the support information, when it is determined that the auditory environment is not suitable for presentation of the support information, postpone at least a presentation operation of the support information that utilizes an auditory sense of the user.

10. The non-transitory computer readable medium according to claim 8, wherein the one or more instructions further cause the computer to execute:
in the processing for estimating the surrounding environment, acquire visual sensor information corresponding to a visual environment around the vehicle and, by comparing a feature amount included in the acquired visual sensor information with a second determination condition set in advance, determine whether or not the visual environment around the vehicle is suitable for presentation of the support information; and
in the processing of controlling a presentation operation of the support information, when it is determined that the visual environment is not suitable for presentation of the support information, postpone at least a presentation operation of the support information that utilizes a visual sense of the user.

11. The non-transitory computer readable medium according to claim 8, wherein the one or more instructions further cause the computer to execute:
vehicle state estimating processing for acquiring sensor information corresponding to a vibration of the vehicle and, by comparing a feature amount included in the acquired sensor information with a third determination condition set in advance, determine whether or not the vibration of the vehicle is suitable for presentation of the support information; and
in the processing of controlling a presentation operation of the support information, when it is determined that the vibration of the vehicle is not suitable for presentation of the support information, further perform control to postpone at least a presentation operation of the support information that utilizes a haptic sense of the user.

12. The non-transitory computer readable medium according to claim 8, wherein the one or more instructions further cause the computer to execute:
driving skill estimation processing for acquiring sensor information corresponding to a driving skill of the user for the vehicle and, by comparing a feature amount included in the acquired sensor information corresponding to the driving skill with a fourth determination condition set in advance, determine whether or not the driving skill of the user is suitable for presentation of the support information; and
in the processing of controlling a presentation operation of the support information, when it is determined that the driving skill of the user is not suitable for presentation of the support information, further perform control to postpone a presentation operation of the support information with respect to the user.

13. The presentation control method of claim 7, further comprising:
in the processing for estimating the surrounding environment, acquire auditory sensor information corresponding to a surrounding auditory environment of the vehicle and, by comparing a feature amount included in the acquired auditory sensor information with a first determination condition set in advance, determine whether or not the surrounding auditory environment is suitable for presentation of the support information; and
in the processing of controlling a presentation operation of the support information, when it is determined that the auditory environment is not suitable for presentation of the support information, postpone at least a presentation operation of the support information that utilizes an auditory sense of the user.

14. The presentation control method of claim 7, further comprising:
in the processing for estimating the surrounding environment, acquire visual sensor information corresponding to a visual environment around the vehicle and, by comparing a feature amount included in the acquired visual sensor information with a second determination condition set in advance, determine whether or not the visual environment around the vehicle is suitable for presentation of the support information; and
in the processing of controlling a presentation operation of the support information, when it is determined that the visual environment is not suitable for presentation of the support information, postpone at least a presentation operation of the support information that utilizes a visual sense of the user.

15. The presentation control method of claim 7, further comprising:
executing vehicle state estimating processing for acquiring sensor information corresponding to a vibration of the vehicle and, by comparing a feature amount included in the acquired sensor information with a third determination condition set in advance, determining whether or not the vibration of the vehicle is suitable for presentation of the support information; and
in the processing of controlling a presentation operation of the support information, when it is determined that the vibration of the vehicle is not suitable for presentation of the support information, further perform control to postpone at least a presentation operation of the support information that utilizes a haptic sense of the user.

16. The presentation control method of claim 7, further comprising:
executing driving skill estimation processing for acquiring sensor information corresponding to a driving skill of the user for the vehicle and, by comparing a feature amount included in the acquired sensor information corresponding to the driving skill with a fourth determination condition set in advance, determining whether or not the driving skill of the user is suitable for presentation of the support information; and
in the processing of controlling a presentation operation of the support information, when it is determined that the driving skill of the user is not suitable for presentation of the support information, further perform control to postpone a presentation operation of the support information with respect to the user.
